(19) United States
(12) Patent Application Publication
(10) Pub. No.: US 2026/0370254 A1
(43) Pub. Date: Nov. 19, 2026

(54) ENCODER AND DECODER USING SELECTIVE SHAPING AND METHOD FOR OPERATING THE SAME

(71) Applicant: Electronics and Telecommunications Research Institute, Daejeon (KR)

(72) Inventors: Byeongho CHO, Daejeon (KR); Soo Young PARK, Daejeon (KR); Jongmo SUNG, Daejeon (KR); Jung Won KANG, Daejeon (KR); Seung Kwon BEACK, Daejeon (KR); Woo-taek LIM, Daejeon (KR); Inseon JANG, Daejeon (KR)

(73) Assignee: Electronics and Telecommunications Research Institute, Daejeon (KR)

(21) Appl. No.: 19/567,489

(22) Filed: Mar. 16, 2026

(30) Foreign Application Priority Data
Mar. 21, 2025 (KR) 10-2025-0036512
Sep. 5, 2025 (KR) 10-2025-0126756
Feb. 19, 2026 (KR) 10-2026-0031097

(51) Int. Cl. H04B 1/66; H04B 14/00

(52) U.S. Cl. CPC H04B 1/667; H04B 14/00

(57) ABSTRACT

An encoder and a decoder using selective shaping and a method of operating the same are disclosed. The disclosed decoder includes a processor and memory for storing instructions, and the instructions, when executed by the processor, cause the decoder to acquire a bitstream generated by encoding a target block among a plurality of blocks divided from an original signal, determine a prediction block that predicts the target block, based on the bitstream and remaining blocks excluding the target block among the plurality of blocks, determine, from the bitstream, a shaped residual block based on a difference between the target block and the prediction block, divide the shaped residual block into a plurality of sub-blocks, and perform inverse-shaping on a portion of the plurality of sub-blocks in a frequency domain to determine a residual block, and generate the original signal by decoding the target block based on the inverse-shaped residual block and the prediction block.

### TECHNICAL FIELD

The following disclosure relates to an encoder and a decoder using selective shaping and a method of operating the same.

### BACKGROUND OF THE INVENTION

Signal coding is a technique for compressing and transmitting signals, and various audio coding schemes are being researched to efficiently compress audio signals while reducing loss. Signal coding schemes may be classified into lossy coding schemes and lossless coding schemes depending on whether signal loss occurs during encoding and decoding processes.

Entropy coding is one of the lossless data compression schemes that may compress signals using statistical characteristics of a signal based on information theory. Entropy coding may use, for example, Huffman coding, arithmetic coding, and context adaptive arithmetic coding (CAAC).

The above description is information the inventor(s) acquired during the course of conceiving the present disclosure, or already possessed at the time, and is not necessarily art publicly known before the present application is filed.

### DISCLOSURE OF THE INVENTION

### Technical Goals

Various embodiments may encode and decode an original signal through selective shaping of a residual block by using the redundancy of the residual block based on a difference between a target block of the original signal and a prediction block for the target block.

Various embodiments may encode and decode an original signal by dividing a residual block for a target block into a plurality of sub-blocks, and selectively shaping a portion of the plurality of sub-blocks in a frequency domain according to a shaping mode.

Other objects and advantages of the present disclosure may be understood by the following description and will become more apparent by the embodiments of the present disclosure. In addition, it will be apparent that the objects and advantages of the present disclosure may be readily realized by the means and combinations thereof recited in the claims.

### Technical Solutions

A decoder according to an embodiment includes a processor and memory storing instructions, wherein the instructions, when executed by the processor, cause the decoder to acquire a bitstream generated by encoding a target block among a plurality of blocks divided from an original signal, determine a prediction block that predicts the target block, based on the bitstream and remaining blocks excluding the target block among the plurality of blocks, determine, from the bitstream, a shaped residual block based on a difference between the target block and the prediction block, divide the shaped residual block into a plurality of sub-blocks, and perform inverse-shaping on a portion of the plurality of sub-blocks in a frequency domain to determine a residual block, and generate the original signal by decoding the target block based on the inverse-shaped residual block and the prediction block.

The instructions, when executed by the processor, may cause the decoder to determine a shaping mode used for encoding the target block from the bitstream, and perform inverse-shaping according to the determined shaping mode.

The instructions, when executed by the processor, may cause the decoder to perform inverse-shaping by amplifying values of sub-blocks within a predetermined frequency domain among the plurality of sub-blocks.

The instructions, when executed by the processor, may cause the decoder to select a portion of the plurality of sub-blocks by determining indices of sub-blocks shaped during encoding from the bitstream.

The instructions, when executed by the processor, may cause the decoder to perform inverse-shaping on the selected sub-blocks using a linear attenuation window used for encoding the target block.

The instructions, when executed by the processor, may cause the decoder to perform inverse-shaping on the selected sub-blocks using an attenuation window configured to attenuate a predetermined frequency domain used for encoding the target block.

The instructions, when executed by the processor, may cause the decoder to determine parameters used for encoding the target block from the bitstream, and determine the shaped residual block by performing entropy decoding on the bitstream using the determined parameters.

The instructions, when executed by the processor, may cause the decoder to determine the prediction block based on blocks reconstructed from the original signal prior to the target block.

An encoder according to an embodiment includes a processor and memory storing instructions, wherein the instructions, when executed by the processor, cause the encoder to divide an original signal into a plurality of blocks, and determine a target block to be encoded among the plurality of blocks, determine a prediction block that predicts the target block, based on remaining blocks excluding the target block among the plurality of blocks, determine a residual block for the target block based on a difference between the target block and the prediction block, divide the residual block into a plurality of sub-blocks, and shape a portion of the plurality of sub-blocks in a frequency domain, and generate a bitstream by encoding the original signal using the plurality of shaped sub-blocks.

The instructions, when executed by the processor, may cause the encoder to for each of the plurality of blocks, select one of a plurality of predetermined shaping modes based on rate-distortion, and shape the target block according to the shaping mode selected for the target block.

The instructions, when executed by the processor, may cause the encoder to perform shaping by attenuating values of sub-blocks within a predetermined frequency domain among the plurality of sub-blocks.

The instructions, when executed by the processor, may cause the encoder to select a portion of the plurality of sub-blocks based on energy values of the plurality of sub-blocks.

The instructions, when executed by the processor, may cause the encoder to shape the selected sub-blocks by applying a linear attenuation window to the selected sub-blocks.

The instructions, when executed by the processor, may cause the encoder to shape the selected sub-blocks by applying an attenuation window configured to attenuate a predetermined frequency domain to the selected sub-blocks.

The instructions, when executed by the processor, may cause the encoder to generate the bitstream by performing entropy encoding on a residual block including the plurality of shaped sub-blocks.

The instructions, when executed by the processor, may cause the encoder to generate the bitstream using information about a shaping mode used for shaping and an index for a portion of shaped sub-blocks among the plurality of sub-blocks.

The instructions, when executed by the processor, may cause the encoder to determine the prediction block based on blocks reconstructed from the original signal prior to the target block.

A method of operating a decoder, according to an embodiment, includes acquiring a bitstream generated by encoding a target block among a plurality of blocks divided from an original signal, determining a prediction block that predicts the target block, based on the bitstream and remaining blocks excluding the target block among the plurality of blocks, determining, from the bitstream, a shaped residual block based on a difference between the target block and the prediction block, dividing the shaped residual block into a plurality of sub-blocks, and performing inverse-shaping on a portion of the plurality of sub-blocks in a frequency domain to determine a residual block, and generating the original signal by decoding the target block based on the inverse-shaped residual block and the prediction block.

The performing of inverse-shaping on a portion of the plurality of sub-blocks in a frequency domain may include determining a shaping mode used for encoding the target block from the bitstream, and performing inverse-shaping according to the determined shaping mode.

The performing of inverse-shaping on a portion of the plurality of sub-blocks in a frequency domain may include performing inverse-shaping by amplifying values of sub-blocks within a predetermined frequency range among the plurality of sub-blocks.

### Effects of the Invention

Various embodiments may improve encoding compression efficiency and performance by removing redundant information of residual signals for target blocks.

Various embodiments may operate with the same algorithm in both encoding and decoding, so that a bit rate may be reduced while maintaining the quality of an original signal during decoding.

Various embodiments may provide a plurality of shaping modes for selectively shaping a residual signal for a target block.

### BRIEF DESCRIPTION OF DRAWINGS

FIG. 1 is a diagram illustrating an encoder and a decoder according to an embodiment.

FIG. 2 is a diagram illustrating an encoding process and a decoding process according to an embodiment.

FIG. 3 is a diagram illustrating a decoding process using selective shaping according to an embodiment.

FIG. 4 is a diagram illustrating an encoding process of an encoder using selective shaping according to an embodiment.

FIGS. 5 and 6 are diagrams illustrating a first shaping mode according to an embodiment.

FIGS. 7 to 10 are diagrams illustrating a second shaping mode and a third shaping mode according to an embodiment.

FIGS. 11 and 12 are diagrams illustrating a fourth shaping mode according to an embodiment.

FIG. 13 is a flowchart illustrating a method of operating a decoder according to an embodiment.

FIG. 14 is a flowchart illustrating a method of operating an encoder according to an embodiment.

FIG. 15 is a block diagram illustrating a decoder according to an embodiment.

FIG. 16 is a block diagram illustrating an encoder according to an embodiment.

### DETAILED DESCRIPTION FOR CARRYING OUT THE INVENTION

The following structural or functional descriptions of embodiments described herein are merely intended for the purpose of describing the embodiments described herein and may be implemented in various forms. Accordingly, the embodiments are not construed as limited to the disclosure and should be understood to include all changes, equivalents, and replacements within the idea and the technical scope of the disclosure.

As used herein, “A or B,” “at least one of A and B,” “at least one of A or B,” “A, B or C,” “at least one of A, B and C,” “at least one of A, B, or C,” and “one or a combination of at least two of A, B, and C,” each of which may include any one of the items listed together in the corresponding one of the phrases, or all possible combinations thereof. Although terms, such as first, second, and the like, may be used herein to describe various components, these terms should be used only to distinguish one component from another component. For example, a first component may be referred to as a second component, or similarly, the second component may be referred to as the first component.

When it is mentioned that one component is “connected” to another component, it may be understood that the one component is directly connected to or accessed by another component or that still other component is interposed between the two components.

The singular forms “a”, “an”, and “the” are intended to include the plural forms as well, unless the context clearly indicates otherwise. It will be understood that the terms “comprises/comprising” and/or “includes/including” when used herein, specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements, and a repeated description related thereto is omitted.

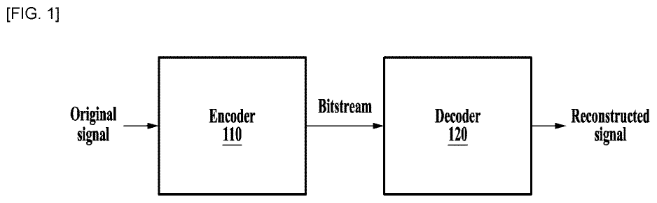

FIG. 1 is a diagram illustrating an encoder and a decoder according to an embodiment.

Referring to FIG. 1, a coding system for a signal may include an encoder 110 and a decoder 120.

The signal may represent continuous one-dimensional waveform data. For example, the signal may be an audio signal or a biosignal (e.g., an electrocardiogram signal, electromyogram signal, or brainwave), but embodiments are not limited thereto. In addition, according to embodiments, the signal may be high-dimensional (e.g., two-dimensional or three-dimensional) waveform data.

The encoder 110 may compress an input original signal to generate a bitstream. The bitstream may include information about the compressed original signal and side information for reconstructing the original signal.

The decoder 120 may receive the bitstream generated by the encoder 110. The decoder 120 may generate a reconstructed signal by reconstructing the original signal from the bitstream. With respect to the coding of the signal, reconstructing a signal identical to the original signal may determine the performance of the encoder 110 and the decoder 120.

According to an embodiment, the encoder 110 may divide the original signal into a plurality of blocks, and, for a target block to be encoded, may determine a prediction block that predicts the target block based on remaining blocks excluding the target block. The encoder 110 may encode the original signal by shaping a residual block based on a difference between the target block and the prediction block. In addition, the decoder 120 corresponding to the encoder 110 may decode the original signal by determining the target block by performing inverse-shaping on the shaped residual block. The encoder 110 and the decoder 120 may increase compression efficiency and improve compression performance by shaping to remove redundant information from a residual block.

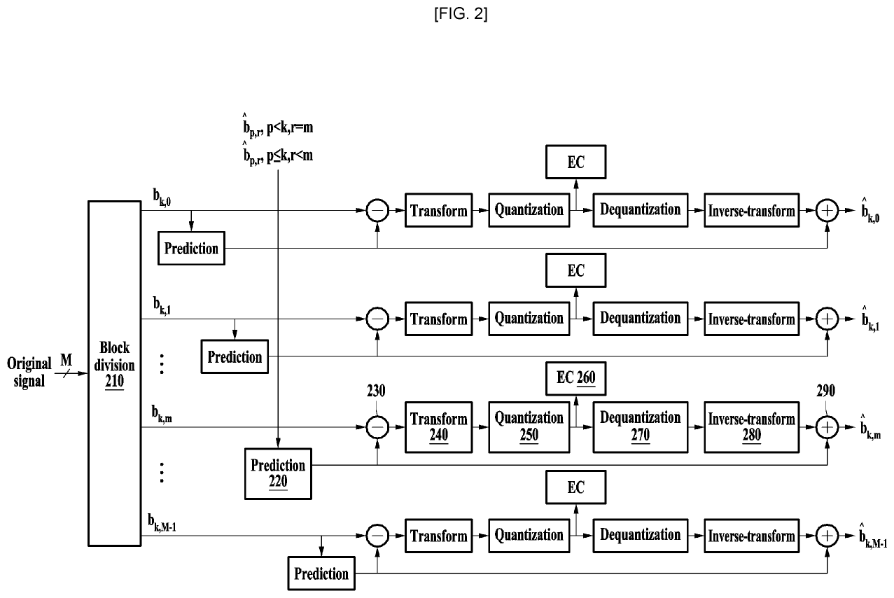

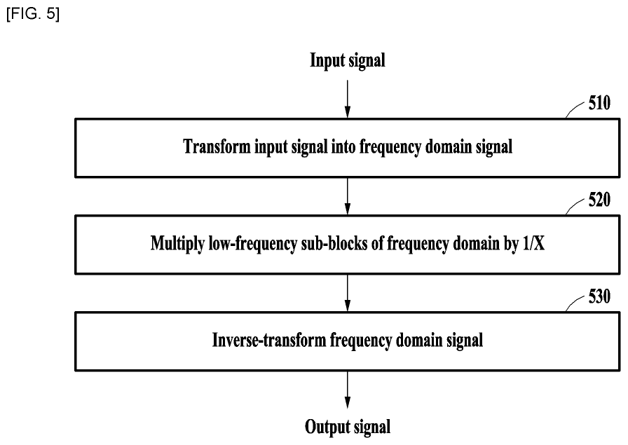

The operations of the decoder 120 and the encoder 110 are described in detail below with reference to FIGS. 2 to 4, and a process of performing selective shaping is described in detail below with reference to FIGS. 5 to 12.

FIG. 2 is a diagram illustrating an encoding process and a decoding process according to an embodiment.

Referring to FIG. 2, an encoder may encode an original signal by performing block prediction, transform, quantization, and entropy encoding, and a decoder may reconstruct the original signal by performing entropy decoding, inverse quantization, inverse transform, and block prediction in response to the encoding. In FIG. 2, operations 220 to 290 may be performed, by the encoder or decoder, on each block divided from the original signal.

In operation 210, the encoder may divide the original signal (e.g., a biomedical signal) into a plurality of blocks. In addition, the encoder may divide signals of each channel included in the original signal into a plurality of blocks. Each block may include one or more sample values of the original signal. In an example of FIG. 2, the encoder may divide the original signal into M (M is a natural number) blocks. The number of divided blocks may be determined differently according to embodiments. In FIG. 2, a block b_{k,m} divided from the original signal may represent an m-th block of channel k of the original signal. The encoder may determine a block currently to be encoded as a target block, and the decoder may determine a block currently to be decoded as a target block.

In operation 220, the encoder and decoder may determine a prediction block by predicting the target block based on remaining blocks excluding the target block among the plurality of blocks. In an embodiment, the encoder and decoder may determine the prediction block using blocks reconstructed prior to the target block among the plurality of blocks. For example, the encoder and decoder may determine the prediction block using blocks of a different channel from the target block or blocks of the same channel that are reconstructed prior to the target block. The encoder and decoder may store information about the reconstructed blocks and determine the prediction block using the stored reconstructed blocks.

In operation 230, the encoder may determine a residual block for the target block based on a difference between the target block and the prediction block. In an embodiment, the encoder may determine a residual block based on a difference between sample values between the target block and the prediction block.

In operation 240, the encoder may transform the residual block into a frequency domain. For example, the encoder may transform the residual block into a frequency domain using a discrete cosine transform (DCT), a discrete sine transform (DST), or a discrete Fourier transform (DFT), but embodiments are not limited thereto, and various transform schemes may be used.

In operation 250, the encoder may quantize the residual block transformed into the frequency domain.

In operation 260, the encoder may generate a bitstream by performing entropy encoding on the transformed and quantized residual block. The decoder that receives the bitstream may determine the transformed and quantized residual block by performing entropy decoding on the bitstream. Entropy coding may use, for example, Huffman coding, arithmetic coding, or context adaptive arithmetic coding (CAAC), but embodiments are not limited thereto.

In operation 270, the decoder may dequantize the transformed and quantized residual block. The decoder may use a dequantization scheme corresponding to the quantization scheme used for encoding the residual block.

In operation 280, the decoder may determine the residual block by inverse-transforming the dequantized residual block. The decoder may use an inverse-transform scheme corresponding to the transform scheme used for encoding the residual block.

In operation 290, the decoder may reconstruct the target block based on the determined residual block and prediction block. For example, the decoder may reconstruct the target block by summing sample values of the determined residual block and prediction block.

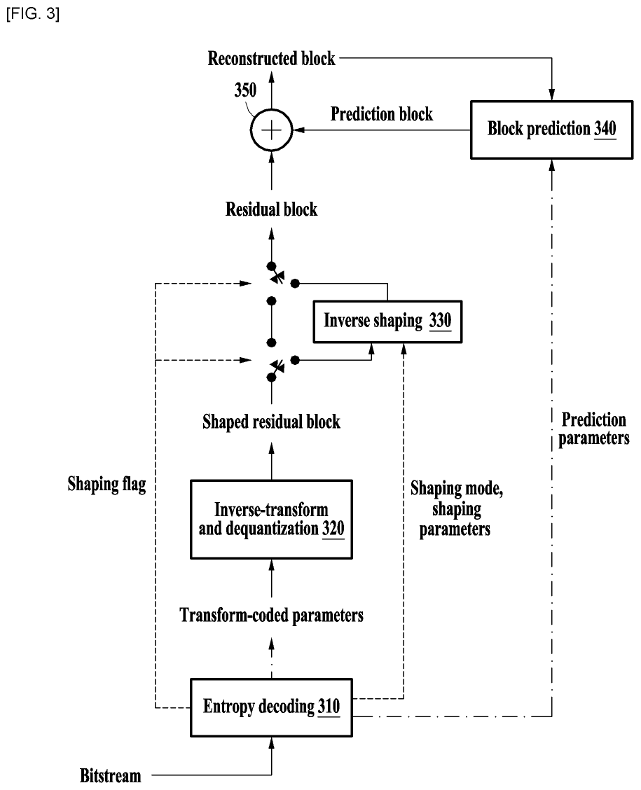

According to an embodiment, the encoder may selectively shape the residual block in the frequency domain after operation 240. In response to the shaping of the encoder, the decoder may selectively perform inverse-shaping on the residual block in the frequency domain after operation 270. Selective shaping is further described below with reference to FIGS. 3 to 12.

FIG. 3 is a diagram illustrating a decoding process using selective shaping according to an embodiment.

Referring to FIG. 3, a decoder may selectively perform inverse-shaping on a residual block in response to selective shaping of an encoder. In the following embodiments, operations may or may not be performed sequentially. For example, the order of the operations may be changed and at least two of the operations may be performed in parallel. Operations 310 to 350 may be performed by at least one component (e.g., a processor) of the decoder.

In operation 310, the decoder may perform entropy decoding on a bitstream received from the encoder. The decoder may determine information about residual blocks included in the bitstream, information about selective shaping, and information about block prediction through entropy decoding. For example, the decoder may determine, from the bitstream, transform-coded parameters, a shaping mode used during encoding, shaping parameters, a shaping flag, and prediction parameters for a residual block.

In operation 320, the decoder may determine a residual block shaped by the encoder by inverse-transforming and dequantizing transform-coded parameters for the residual block. In operation 330, the decoder may perform inverse-shaping on the shaped residual block using at least one of a shaping mode, shaping parameters and a shaping flag. Inverse-shaping performed during decoding may be an inverse process of shaping performed during encoding. The shaping mode may represent any one of a plurality of shaping schemes (e.g., a first shaping mode to a fourth shaping mode) used by the encoder and the decoder. The shaping parameters may include an index of a sub-block on which shaping is performed. In addition, the shaping parameters may include window information used for shaping. The shaping flag may indicate whether shaping is performed on a corresponding residual block. For example, the shaping flag may be a 1-bit flag indicating “on” or “off” depending on whether shaping is performed. The decoder may reconstruct the residual block through inverse-shaping.

In operation 340, the decoder may determine a prediction block by predicting a target block using the prediction parameters. The decoder may determine the prediction block using blocks reconstructed prior to the target block. The decoder may perform block prediction in the same manner as the encoder by using the prediction parameters.

In operation 350, the decoder may reconstruct the target block based on the residual block and the prediction block. The decoder may store the reconstructed target block in a buffer of the decoder.

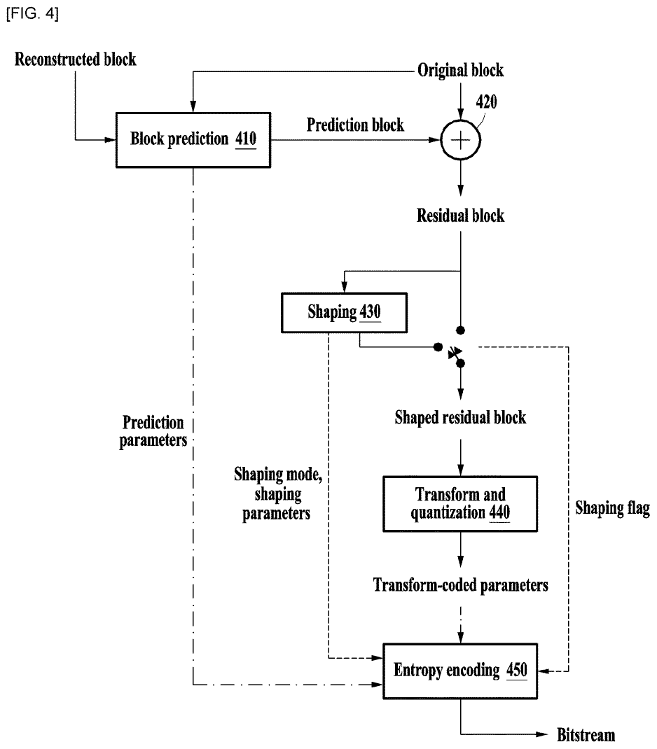

FIG. 4 is a diagram illustrating an encoding process of an encoder using selective shaping according to an embodiment.

Referring to FIG. 4, the encoder may selectively shape a residual block. In the following embodiments, operations may or may not be performed sequentially. For example, the order of the operations may be changed and at least two of the operations may be performed in parallel. Operations 410 to 450 may be performed by at least one component (e.g., a processor) of the encoder.

In operation 410, the encoder may divide an original signal into a plurality of blocks, and predict a target block to be encoded to determine a prediction block. The encoder may determine the prediction block based on remaining blocks, excluding the target block, among the plurality of blocks divided from the original signal. The encoder may determine the prediction block by using blocks reconstructed prior to the target block among the plurality of blocks.

In operation 420, the encoder may determine a residual block for the target block based on a difference between the target block and the prediction block.

In operation 430, the encoder may selectively shape the residual block in a frequency domain. The encoder may select one of a plurality of predetermined shaping modes, and shape the residual block according to the selected shaping mode. In an embodiment, the encoder may select any one of the plurality of predetermined shaping modes based on rate-distortion of the residual block. For example, for each of the plurality of predetermined shaping modes, the encoder may shape the residual block according to the corresponding shaping mode, and calculate distortion between a block determined through local decoding and the residual block. For example, the encoder may determine distortion based on a peak signal-to-noise ratio (PSNR). In addition, the encoder may determine bit usage for performing shaping for each of the plurality of shaping modes. The encoder, based on bit usages determined for each of the plurality of predetermined shaping modes, may select a shaping mode having the lowest weighted sum (e.g., R+λD) of distortion D and bit usage R among the plurality of predetermined shaping modes. The plurality of predetermined shaping modes is described in detail below with reference to FIGS. 5 to 12.

The encoder may determine a shaping mode for each of the blocks divided from the original signal. For example, a shaping mode for a target block to be currently shaped and a shaping mode for a block to be shaped after the target block may be determined differently from each other.

The encoder may generate information about selective shaping. In an embodiment, the encoder may generate a shaping mode, shaping parameters, and a shaping flag for selective shaping of the residual block. The shaping mode, shaping parameters and shaping flag may be generated for each of the blocks divided from the original signal.

In operation 440, the encoder may transform and quantize the shaped residual block.

In operation 450, the encoder may generate a bitstream by performing entropy encoding on transform-coded parameters for the residual block. The encoder may generate the bitstream by further performing entropy encoding on information about at least one of prediction parameters for block prediction, a shaping mode, shaping parameters, and a shaping flag. A decoder that receives the bitstream may use the information to perform decoding of the target block.

When performing entropy encoding on the shaping parameters, the encoder may perform adaptive entropy encoding using context of a previously encoded channel. In addition, context for a shaping mode may be determined by a selective shaping mode of the previous channel. In this case, the number of contexts for the shaping mode may be determined according to the number of shaping modes. Additionally, when performing selective shaping, context for a sub-block index may be determined from a sub-block index on which selective shaping is previously performed. The number of contexts for the sub-block index may be determined by the number of shaping modes. The decoder may perform adaptive entropy decoding using the contexts used during encoding.

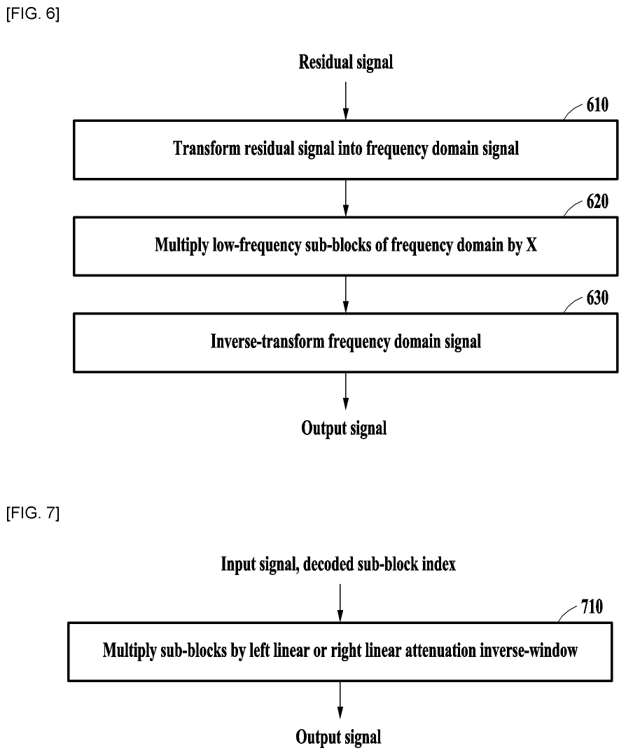

FIGS. 5 and 6 are diagrams illustrating a first shaping mode according to an embodiment.

Referring to FIG. 5, a decoder may perform inverse-shaping on a residual block shaped in a first shaping mode. The first shaping mode may be a shaping mode that attenuates values in a predetermined frequency domain after transform of the residual block. For example, an encoder may shape a residual block by transforming the residual block into a frequency domain and then selectively suppressing signals of low-frequency components. The decoder may perform inverse-shaping on the residual block by amplifying the attenuated low-frequency components in the residual block. In FIG. 5, an input signal may represent a shaped residual block.

In operation 510, the decoder may transform the input signal into the frequency domain. The decoder may transform the residual block into the frequency domain using, for example, a DCT, DST, or DFT, but embodiments are not limited thereto.

In operation 520, the decoder may amplify a predetermined frequency domain in the frequency domain for the shaped input signal. The decoder may divide the shaped input signal into a plurality of sub-blocks, and amplify values of the sub-blocks corresponding to the predetermined frequency domain among the plurality of sub-blocks. The predetermined frequency domain may be a low-frequency component of the shaped input signal, but embodiments are not limited thereto. A ratio at which the decoder amplifies for the predetermined frequency domain may correspond to a ratio at which the encoder attenuates for the predetermined frequency domain. For example, when the low-frequency component is shaped by multiplying the low-frequency component by X (X<1) during encoding, the decoder may perform inverse-shaping on the input signal by multiplying the sub-blocks of the corresponding frequency domain by 1/X.

In operation 530, the decoder may inverse-transform the inverse-shaped input signal.

Referring to FIG. 6, an encoder may shape a residual block in a first shaping mode.

In operation 610, the encoder may transform a residual signal into a frequency domain.

In operation 620, the encoder may attenuate a predetermined frequency domain in the frequency domain for the transformed residual signal. The encoder may divide the shaped input signal into a plurality of sub-blocks, and amplify values of the sub-blocks corresponding to the predetermined frequency domain among the plurality of sub-blocks. For example, the encoder may shape the residual block by multiplying the values of the sub-blocks corresponding to the predetermined frequency domain by X (X<1).

In operation 630, the encoder may inverse-transform the shaped residual signal.

FIGS. 7 to 10 are diagrams illustrating a second shaping mode and a third shaping mode according to an embodiment.

Referring to FIG. 7, a decoder may perform inverse-shaping on a residual block shaped in a second shaping mode or a third shaping mode. The second shaping mode may be a shaping mode that attenuates a portion of sub-blocks of the residual block using a left linear attenuation window. The third shaping mode may be a shaping mode that attenuates a portion of the sub-blocks of the residual block using a right linear attenuation window. The decoder may perform inverse-shaping on the residual block by applying an inverse-window to sub-blocks indicated by a sub-block index in the residual block. In FIG. 7, an input signal may represent a shaped residual block.

In operation 710, the decoder may determine sub-blocks indicated by a sub-block index decoded for an input signal. The decoder may perform inverse-shaping on the input signal by multiplying the corresponding sub-blocks by a left linear or right linear attenuation inverse-window. The linear attenuation inverse-window may be a function corresponding to the linear attenuation window used during encoding.

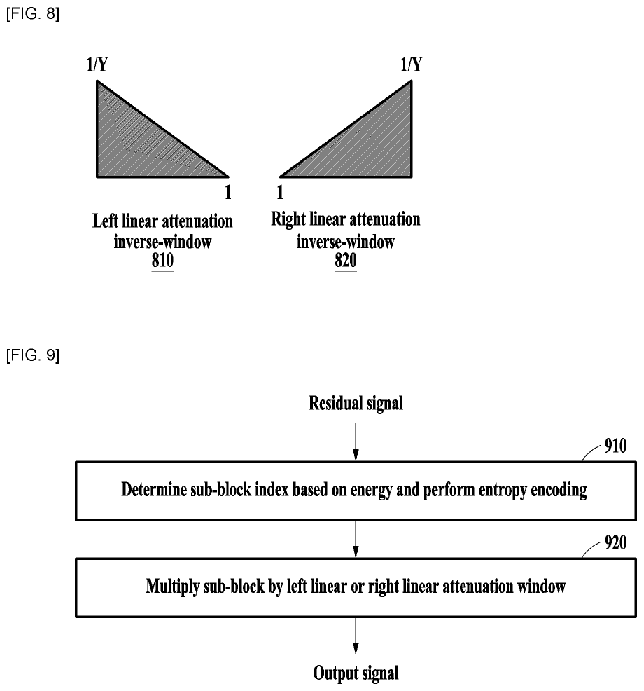

Referring to FIG. 8, a left linear attenuation inverse-window 810 in the second shaping mode and a right linear attenuation inverse-window 820 in the third shaping mode are illustrated as examples. In the example of FIG. 8, the left linear attenuation inverse-window 810 and the right linear attenuation inverse-window 820 may be window functions having a maximum value of 1/Y (Y<1) and a minimum value of 1. However, the left linear attenuation inverse-window 810 and the right linear attenuation inverse-window 820 shown in FIG. 8 are only examples for illustrative purposes and embodiments are not limited thereto.

Referring to FIG. 9, an encoder may shape a residual block in a second shaping mode or a third shaping mode.

In operation 910, the encoder may divide the residual signal into a plurality of sub-blocks, and determine an index of the sub-blocks to which a linear attenuation window is to be applied, based on energy of the sub-blocks. For example, the encoder may divide the residual signal into a predetermined number of sub-blocks, and select a sub-block having a maximum energy value among the divided sub-blocks. In addition, the encoder may perform entropy encoding on an index value of the selected sub-block.

In operation 920, the encoder may shape the residual block by linearly attenuating the selected sub-block by multiplying the selected sub-block by a left linear or right linear attenuation window.

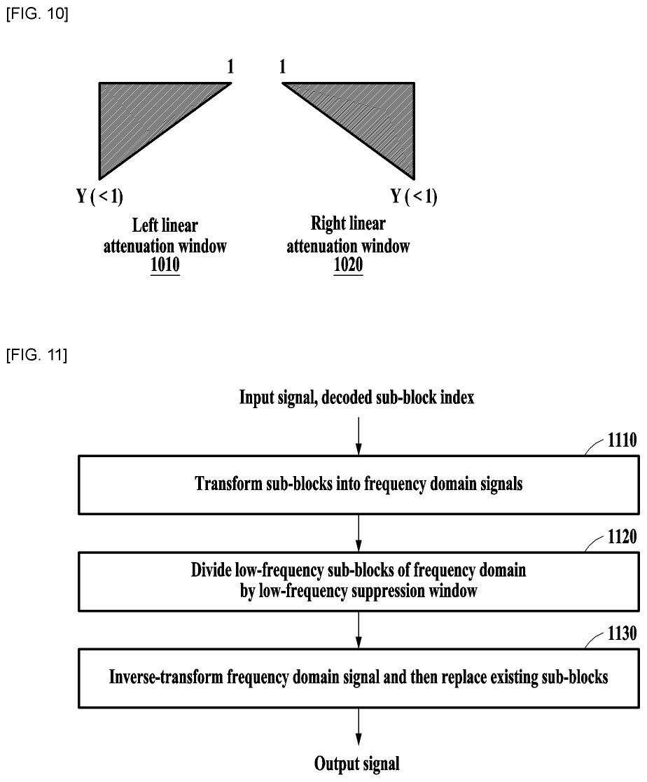

Referring to FIG. 10, a left linear attenuation window 1010 in a second shaping mode and a right linear attenuation window 1020 in a third shaping mode are illustrated as examples. In the example of FIG. 10, the left linear attenuation window 1010 and the right linear attenuation window 1020 may be window functions having a minimum value of Y (Y<1) and a maximum value of 1. For example, the left linear attenuation window 1010 may be a window with linear characteristics in which a left value is less than 1 and a right value is 1, and the right linear attenuation window 1020 may be a window with linear characteristics in which the left value is 1 and the right value is less than 1. Here, a value less than 1 may be determined differently depending on a target bit rate of the residual signal, and the value may be shared equally between the encoder and the decoder. However, the left linear attenuation window 1010 and the right linear attenuation window 1020 shown in FIG. 10 are only examples for illustrative purposes and embodiments are not limited thereto. The left linear attenuation window 1010 and the right linear attenuation window 1020 may be shared equally between the encoder and the decoder.

For example, the left linear attenuation window 1010 and the right linear attenuation window 1020 may be determined by fixed-point operations. In addition, the inverse-window corresponding to the left linear attenuation window 1010 and the right linear attenuation window 1020 may be implemented by fixed-point operations such that element-wise products of the left linear attenuation window 1010 and the right linear attenuation window 1020 have a value that is approximately 1 or 1, respectively.

In an embodiment, a rate of linear attenuation through the left linear attenuation window 1010 and the right linear attenuation window 1020 may be shared equally between the encoder and the decoder. In addition, according to embodiments, an attenuation rate in the left linear attenuation window 1010 and the right linear attenuation window 1020 may not be attenuated linearly, but may be attenuated exponentially, logarithmically, or in other non-linearly manners, and an attenuation form may be shared equally between the encoder and the decoder.

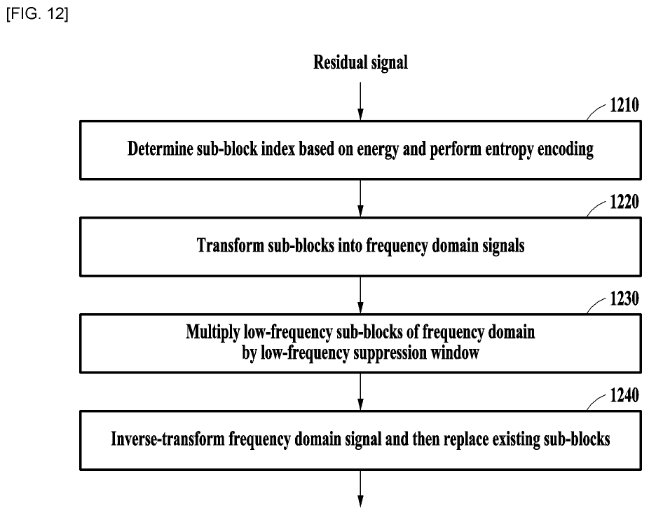

FIGS. 11 and 12 are diagrams illustrating a fourth shaping mode according to an embodiment.

Referring to FIG. 11, a decoder may perform inverse-shaping on a residual block shaped in the fourth shaping mode. The fourth shaping mode may be a shaping mode that applies a linear attenuation window to a portion of sub-blocks of the residual block in a frequency domain. The decoder may perform inverse-shaping on the residual block by transforming, into a frequency domain, sub-blocks indicated by a sub-block index in the residual block, and dividing the transformed sub-blocks by a linear attenuation window. In FIG. 11, an input signal may represent a shaped residual block.

In operation 1110, the decoder may determine sub-blocks indicated by a sub-block index decoded for the input signal. The decoder may transform the determined sub-blocks into frequency domain signals.

In operation 1120, the decoder may perform inverse-shaping on the sub-blocks by dividing the sub-blocks transformed into the frequency domain by an attenuation window used during encoding. In another example, the decoder may multiply the sub-blocks transformed into the frequency domain by an inverse-window corresponding to the attenuation window used during encoding.

In operation 1130, the decoder may perform inverse-transform on the sub-blocks to which the attenuation window is applied. The decoder may perform inverse-shaping on the residual signal by replacing the sub-blocks determined in operation 1110 with the sub-blocks inverse-shaped in operation 1120.

Referring to FIG. 12, an encoder may shape a residual block in a fourth shaping mode.

In operation 1210, the encoder may divide the residual signal into a plurality of sub-blocks, and determine an index of the sub-blocks to which an attenuation window is to be applied, based on energy of the sub-blocks. For example, the encoder may divide the residual signal into a predetermined number of sub-blocks, and select a sub-block having a maximum energy value among the divided sub-blocks. In addition, the encoder may perform entropy encoding on an index value of the selected sub-block.

In operation 1220, the encoder may transform the corresponding sub-block into frequency domain signals.

In operation 1230, the encoder may shape the residual block by attenuating the corresponding sub-block by multiplying the corresponding sub-block by an attenuation window. For example, the attenuation window may be a left linear or right linear attenuation window, but embodiments are not limited thereto. For example, the left linear or right linear attenuation window may be a low-frequency suppression window, which is a window that partially shapes low-frequency coefficients of a sub-block.

In operation 1240, the encoder may perform inverse-transform on the sub-blocks of the shaped frequency domain. The encoder may shape the residual signal by replacing the sub-blocks determined in operation 1210 with the sub-blocks shaped in operation 1230.

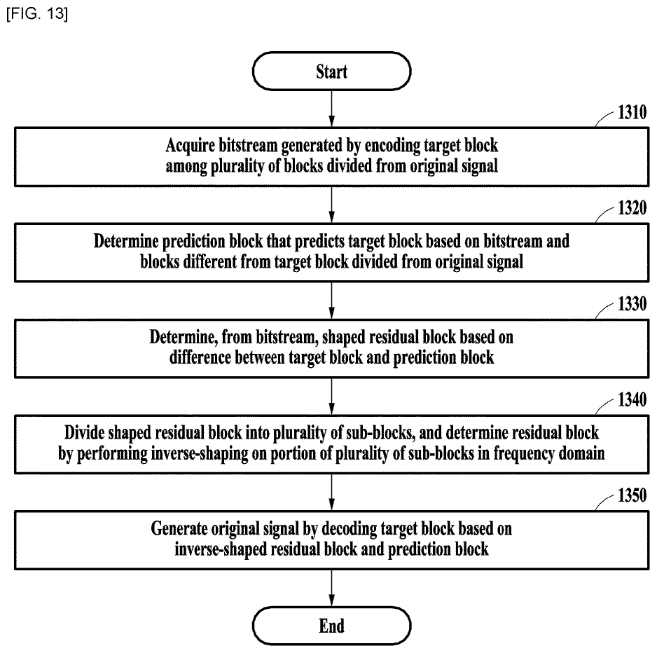

FIG. 13 is a flowchart illustrating a method of operating a decoder according to an embodiment.

In the following embodiments, operations may or may not be performed sequentially. For example, the order of the operations may be changed and at least two of the operations may be performed in parallel. Operations 1310 to 1350 may be performed by at least one component (e.g., a processor) of the decoder.

In operation 1310, the decoder may acquire a bitstream generated by encoding a target block among a plurality of blocks divided from an original signal.

In operation 1320, the decoder may determine a prediction block that predicts the target block, based on the bitstream and remaining blocks excluding the target block among the plurality of blocks. The decoder may determine the prediction block based on blocks reconstructed from the original signal prior to the target block.

In operation 1330, the decoder may determine, from the bitstream, a shaped residual block based on a difference between the target block and the prediction block. The decoder may determine parameters used to encode the target block from the bitstream, and determine the shaped residual block by performing entropy decoding on the bitstream using the parameters.

In operation 1340, the decoder may divide the shaped residual block into a plurality of sub-blocks, and determine a residual block by performing inverse-shaping on a portion of the plurality of sub-blocks in a frequency domain. The decoder may determine, from the bitstream, a shaping mode used for encoding the target block, and perform inverse-shaping according to the shaping mode. The decoder may perform inverse-shaping by amplifying values of sub-blocks within a predetermined frequency range among the plurality of sub-blocks. The decoder may select a portion of the plurality of sub-blocks by determining indices of the sub-blocks shaped during encoding from the bitstream. The decoder may perform inverse-shaping on the selected sub-blocks using a linear attenuation window used for encoding the target block. The decoder may perform inverse-shaping on the selected sub-blocks using an attenuation window that attenuates a predetermined frequency domain used for encoding the target block.

In operation 1350, the decoder may generate the original signal by decoding the target block based on the inverse-shaped residual block and the prediction block.

The descriptions provided with reference to FIGS. 1 to 12 may apply to the operations shown in FIG. 13, and thus, further detailed descriptions are omitted.

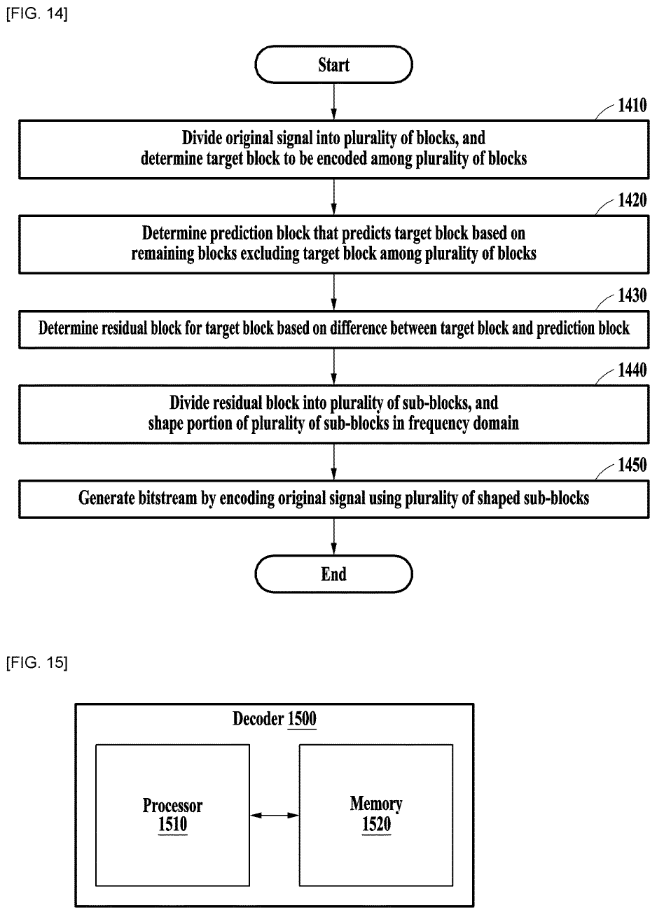

FIG. 14 is a flowchart illustrating a method of operating an encoder according to an embodiment.

In the following embodiments, operations may or may not be performed sequentially. For example, the order of the operations may be changed and at least two of the operations may be performed in parallel. Operations 1410 to 1450 may be performed by at least one component (e.g., a processor) of the encoder.

In operation 1410, the encoder may divide an original signal into a plurality of blocks, and determine a target block to be encoded among the plurality of blocks.

In operation 1420, the encoder may determine a prediction block that predicts the target block based on remaining blocks excluding the target block among the plurality of blocks. The encoder may determine the prediction block based on blocks reconstructed from the original signal prior to the target block.

In operation 1430, the encoder may determine a residual block for the target block based on a difference between the target block and the prediction block.

In operation 1440, the encoder may divide the residual block into a plurality of sub-blocks, and shape a portion of the plurality of sub-blocks in a frequency domain. The encoder may, for each of the plurality of blocks, select one of a plurality of predetermined shaping modes based on rate-distortion, and shape the target block according to the selected shaping mode for the target block. The encoder may perform shaping by attenuating values of sub-blocks within a predetermined frequency domain among the plurality of sub-blocks. The encoder may select a portion of the plurality of sub-blocks based on energy values of the plurality of sub-blocks. The encoder may shape the selected sub-blocks by applying a linear attenuation window to the selected sub-blocks. The encoder may shape the selected sub-blocks by applying, to the selected sub-blocks, an attenuation window that attenuates the predetermined frequency domain.

In operation 1450, the encoder may generate a bitstream by encoding the original signal using the plurality of shaped sub-blocks. The encoder may generate the bitstream by performing entropy encoding on a residual block including the plurality of shaped sub-blocks. The encoder may generate the bitstream using information about a shaping mode used for shaping and an index for a shaped portion of sub-blocks among the plurality of sub-blocks.

Since the descriptions provided above with reference to FIGS. 1 to 13 apply to each operation illustrated in FIG. 14, detailed descriptions thereof are omitted.

FIG. 15 is a block diagram illustrating a decoder according to an embodiment.

Referring to FIG. 15, a decoder 1500 may include a processor 1510. The processor 1510 may include at least one processor. In addition, the decoder 1500 may further include memory 1520.

The memory 1520 may store instructions (e.g., programs) executable by the processor 1510. For example, the instructions may include instructions for performing an operation of the processor 1510 and/or an operation of each component of the processor 1510.

The processor 1510 may be a device for executing instructions or programs, or for controlling the decoder 1500, and may include, for example, various processors, such as a central processing unit (CPU) or a graphic processing unit (GPU). The processor 1510 may acquire a bitstream generated by encoding a target block among a plurality of blocks divided from an original signal. The processor 1510 may determine a prediction block that predicts the target block, based on the bitstream and remaining blocks excluding the target block among the plurality of blocks. The processor 1510 may determine a shaped residual block based on a difference between the target block and the prediction block from the bitstream. The processor 1510 may divide the shaped residual block into a plurality of sub-blocks, and determine a residual block by performing inverse-shaping on a portion of the plurality of sub-blocks in a frequency domain. The processor 1510 may generate the original signal by decoding the target block based on the inverse-shaped residual block and the prediction block. The processor 1510 may determine a shaping mode used for encoding the target block from the bitstream, and perform inverse-shaping according to the shaping mode. The processor 1510 may perform inverse-shaping by amplifying values of sub-blocks within a predetermined frequency range among the plurality of sub-blocks. The processor 1510 may select a portion of the plurality of sub-blocks by determining indices of sub-blocks shaped during encoding from the bitstream. The processor 1510 may perform inverse-shaping on the selected sub-blocks using a linear attenuation window used for encoding the target block. The processor 1510 may perform inverse-shaping on the selected sub-blocks using an attenuation window that attenuates a predetermined frequency domain used for encoding the target block. The processor 1510 may determine parameters used to encode the target block from the bitstream, and determine the shaped residual block by performing entropy decoding on the bitstream using the parameters. The processor 1510 may determine the prediction block based on blocks reconstructed from the original signal prior to the target block.

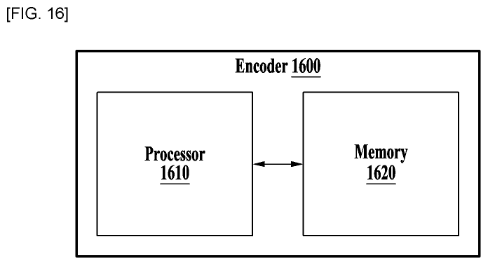

FIG. 16 is a block diagram illustrating an encoder according to an embodiment.

Referring to FIG. 16, an encoder 1600 may include a processor 1610. The processor 1610 may include at least one processor. In addition, the encoder 1600 may further include memory 1620.

The memory 1620 may store instructions (e.g., programs) executable by the processor 1610. For example, the instructions may include instructions for performing an operation of the processor 1610 and/or an operation of each component of the processor 1610.

The processor 1610 may be a device for executing instructions or programs, or for controlling the encoder 1600, and may include, for example, various processors, such as a central processing unit (CPU) or a graphic processing unit (GPU). The processor 1610 may divide an original signal into a plurality of blocks, and determine a target block to be encoded among the plurality of blocks. The processor 1610 may determine a prediction block that predicts the target block based on remaining blocks excluding the target block among the plurality of blocks. The processor 1610 may determine a residual block for the target block based on a difference between the target block and the prediction block. The processor 1610 may divide the residual block into a plurality of sub-blocks, and shape a portion of the plurality of sub-blocks in a frequency domain. The processor 1610 may generate a bitstream by encoding the original signal using the plurality of shaped sub-blocks.

The processor 1610 may, for each of the plurality of blocks, select one of a plurality of predetermined shaping modes based on rate-distortion, and shape the target block according to the selected shaping mode for the target block. The processor 1610 may perform shaping by attenuating values of sub-blocks within a predetermined frequency domain among the plurality of sub-blocks. The processor 1610 may select a portion of the plurality of sub-blocks based on energy values of the plurality of sub-blocks. The processor 1610 may shape the selected sub-blocks by applying a linear attenuation window to the selected sub-blocks. The processor 1610 may shape the selected sub-blocks by applying, to the selected sub-blocks, an attenuation window that attenuates the predetermined frequency domain. The processor 1610 may generate the bitstream by performing entropy encoding on a residual block including the plurality of shaped sub-blocks. The processor 1610 may generate the bitstream using information about a shaping mode used for shaping and an index for a shaped portion of sub-blocks among the plurality of sub-blocks. The processor 1610 may determine the prediction block based on blocks reconstructed from the original signal prior to the target block.

The embodiments described herein may be implemented using hardware components, software components, and/or a combination thereof. For example, the device, the method, and the components described in the embodiments may be implemented using a general-purpose or special-purpose computer, such as a processor, a controller, an arithmetic logic unit (ALU), a digital signal processor (DSP), a microcomputer, a field programmable gate array (FPGA), a programmable logic unit (PLU), a microprocessor, or any other device capable of responding to and executing instructions. A processing device may run an operating system (OS) and one or more software applications that run on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors, or a single processor and a single controller. In addition, different processing configurations are possible, such as parallel processors.

Software may include a computer program, a piece of code, an instruction, or one or more combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The method according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as code produced by a compiler, and files including higher level code that may be executed by a computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the following claims.

1. A decoder comprising:
a processor; and
memory storing instructions,
wherein the instructions, when executed by the processor, cause the decoder to:
acquire a bitstream generated by encoding a target block among a plurality of blocks divided from an original signal,
determine a prediction block that predicts the target block, based on the bitstream and remaining blocks excluding the target block among the plurality of blocks,
determine, from the bitstream, a shaped residual block based on a difference between the target block and the prediction block,
divide the shaped residual block into a plurality of sub-blocks, and perform inverse-shaping on a portion of the plurality of sub-blocks in a frequency domain to determine a residual block, and
generate the original signal by decoding the target block based on the inverse-shaped residual block and the prediction block.

2. The decoder of claim 1, wherein
the instructions, when executed by the processor, cause the decoder to:
determine a shaping mode used for encoding the target block from the bitstream, and perform inverse-shaping according to the determined shaping mode.

3. The decoder of claim 1, wherein
the instructions, when executed by the processor, cause the decoder to:
perform inverse-shaping by amplifying values of sub-blocks within a predetermined frequency domain among the plurality of sub-blocks.

4. The decoder of claim 1, wherein
the instructions, when executed by the processor, cause the decoder to:
select a portion of the plurality of sub-blocks by determining indices of sub-blocks shaped during encoding from the bitstream.

5. The decoder of claim 4, wherein
the instructions, when executed by the processor, cause the decoder to:
perform inverse-shaping on the selected sub-blocks using a linear attenuation window used for encoding the target block.

6. The decoder of claim 5, wherein
the instructions, when executed by the processor, cause the decoder to:
perform inverse-shaping on the selected sub-blocks using an attenuation window configured to attenuate a predetermined frequency domain used for encoding the target block.

7. The decoder of claim 1, wherein
the instructions, when executed by the processor, cause the decoder to:
determine parameters used for encoding the target block from the bitstream, and determine the shaped residual block by performing entropy decoding on the bitstream using the determined parameters.

8. The decoder of claim 1, wherein
the instructions, when executed by the processor, cause the decoder to:
determine the prediction block based on blocks reconstructed from the original signal prior to the target block.

9. An encoder comprising:
a processor; and
memory storing instructions,
wherein the instructions, when executed by the processor, cause the encoder to:
divide an original signal into a plurality of blocks, and determine a target block to be encoded among the plurality of blocks,
determine a prediction block that predicts the target block, based on remaining blocks excluding the target block among the plurality of blocks,
determine a residual block for the target block based on a difference between the target block and the prediction block,
divide the residual block into a plurality of sub-blocks, and shape a portion of the plurality of sub-blocks in a frequency domain, and
generate a bitstream by encoding the original signal using the plurality of shaped sub-blocks.

10. The encoder of claim 9, wherein
the instructions, when executed by the processor, cause the encoder to:
for each of the plurality of blocks, select one of a plurality of predetermined shaping modes based on rate-distortion, and
shape the target block according to the shaping mode selected for the target block.

11. The encoder of claim 9, wherein
the instructions, when executed by the processor, cause the encoder to:
perform shaping by attenuating values of sub-blocks within a predetermined frequency domain among the plurality of sub-blocks.

12. The encoder of claim 9, wherein
the instructions, when executed by the processor, cause the encoder to:
select a portion of the plurality of sub-blocks based on energy values of the plurality of sub-blocks.

13. The encoder of claim 12, wherein
the instructions, when executed by the processor, cause the encoder to:
shape the selected sub-blocks by applying a linear attenuation window to the selected sub-blocks.

14. The encoder of claim 12, wherein
the instructions, when executed by the processor, cause the encoder to:
shape the selected sub-blocks by applying an attenuation window configured to attenuate a predetermined frequency domain to the selected sub-blocks.

15. The encoder of claim 9, wherein
the instructions, when executed by the processor, cause the encoder to:
generate the bitstream by performing entropy encoding on a residual block comprising the plurality of shaped sub-blocks.

16. The encoder of claim 9, wherein
the instructions, when executed by the processor, cause the encoder to:
generate the bitstream using information about a shaping mode used for shaping and an index for a shaped portion of sub-blocks among the plurality of sub-blocks.

17. The encoder of claim 9, wherein
the instructions, when executed by the processor, cause the encoder to:
determine the prediction block based on blocks reconstructed from the original signal prior to the target block.

18. A method of operating a decoder, the method comprising:
acquiring a bitstream generated by encoding a target block among a plurality of blocks divided from an original signal;
based on the bitstream and remaining blocks excluding the target block among the plurality of blocks, determining a prediction block that predicts the target block;
determining, from the bitstream, a shaped residual block based on a difference between the target block and the prediction block;
dividing the shaped residual block into a plurality of sub-blocks, and performing inverse-shaping on a portion of the plurality of sub-blocks in a frequency domain to determine a residual block; and
generating the original signal by decoding the target block based on the inverse-shaped residual block and the prediction block.

19. The method of claim 18, wherein
the performing of inverse-shaping on a portion of the plurality of sub-blocks in a frequency domain comprises
determining a shaping mode used for encoding the target block from the bitstream, and performing inverse-shaping according to the determined shaping mode.

20. The method of claim 18, wherein
the performing of inverse-shaping on a portion of the plurality of sub-blocks in a frequency domain comprises
performing inverse-shaping by amplifying values of sub-blocks within a predetermined frequency range among the plurality of sub-blocks.
